(19) United States
(12) Patent Application Publication
(10) Pub. No.: US 2007/0280572 A1
(43) Pub. Date: Dec. 6, 2007

(54) Torque transmission device lubrication method

(76) Inventor: Christine Sidoroff Coicaud, Thorens Glieres (FR)

Correspondence Address: BACHMAN & LAPOINTE, P.C., 900 CHAPEL STREET, SUITE 1201, NEW HAVEN, CT, 06510, US

(21) Appl. No.: 11/714,323

(22) Filed: Mar. 5, 2007

(30) Foreign Application Priority Data
Jun. 3, 2006 (FR) 06 02003

(51) Int. Cl. F16C 19/00

(52) U.S. Cl. 384/463; 384/470

(57) ABSTRACT

Lubrication method of a torque transmission device, which device comprises a confinement wherein at least one torque transmission part and at least one rotation guiding rolling bearing of the part are arranged, the bearing comprising a fixed part and a rotary part forming together a bearing area wherein. rolling bodies are arranged to enable the relative rotation of the parts, the method providing in the confinement for a lubricant for the torque transmission part and providing in the bearing area for a porous polymer matrix which encapsulates a lubricant for the operation of the bearing, the porous matrix being provided to be in contact with the rolling bodies, at least on a part of the periphery thereof. The invention also relates to such a torque transmission device.

### BACKGROUND

(1) Field of the Invention

The invention relates to a lubrication method of a torque transmission device comprising a confinement wherein at least one torque transmission part and at least one rotation guiding rolling bearing of said part are arranged, along with such a torque transmission device.

In known embodiments, the lubrication of bearings of torque transmission devices such as motor vehicle gearboxes is carried out by projecting, inside the bearing area, oil contained in the box casing, the projections being caused by the rotation of parts inside said box.

In addition, to enable the initial operation of the bearing under acceptable lubrication conditions, the prior art provides for having a quantity of grease inside the bearing area.

However, this type of lubrication for a gearbox bearing involves a number of limitations, which are all the more penalising as the service of the life of the bearing is very closely dependent on its lubrication condition during operation.

These limitations include the fact that the grease initially contained in the bearing area tends to be washed by the oil projections from the box. Over time, this results in an initial operation of the bearing, particularly cold, under insufficient lubrication conditions which are critical for its reliability.

In addition, a lubricant ensuring satisfactory operation of a gearbox is not generally optimal for the lubrication of a bearing, all the more so as the operating conditions of a gearbox bearing are particularly severe.

Finally, the quantity of lubricant received by the bearing depends closely on its positioning inside the gearbox casing, which in some integrations may result in operating the bearings under almost continuously insufficient lubrication conditions.

Moreover, when the gearbox lubricant is polluted, particularly by wear particles, said particles are introduced by projection of the lubricant into the bearing area. This results in the formation of indentations on the bearing tracks, which may cause scaling thereof and therefore possible premature failure of the bearing.

To solve this problem, it was proposed to make a compromise between tightness of the bearing area so as to prevent the penetration of pollutants, while allowing a quantity of lubricant to pass into the box which is sufficient to ensure acceptable lubrication of the bearing.

Typically, these solutions provide for deflectors which are arranged to offer precise clearance with the surfaces of the bearing rings. However, the problem of retaining this clearance over time is posed, particularly in a corrosive environment such as that inside a gearbox casing. In addition, trends in gearbox oils are moving towards greater fluidity, which complicates the practical embodiment of the compromise mentioned above further.

### SUMMARY OF THE INVENTION

The purpose of the invention is to overcome the limitations mentioned above particularly by proposing a method making it possible to lubricate a gearbox bearing in a manner that is both autonomous and substantially independent with respect to the lubrication of said box, so as to do away with the problems of pollution from the box lubricant and optimise the lubrication of the bearing according to its own operating constraints.

To this end, according to a first aspect, the invention proposes a lubrication method of a torque transmission device, said device comprising a confinement wherein at least one torque transmission part and at least one rotation guiding rolling bearing of said part are arranged, said bearing comprising a fixed part and a rotary part forming together a bearing area wherein rolling bodies are arranged to enable the relative rotation of said parts, said method providing in the confinement for a lubricant for the torque transmission part and providing in the bearing area for a porous polymer matrix which encapsulates a lubricant for the operation of the bearing, said porous matrix being provided to be in contact with the rolling bodies, at least on a part of the periphery thereof.

According to a second aspect, the invention proposes a torque transmission device comprising a confinement wherein at least one torque transmission part and at least one rotation guiding rolling bearing of said part are arranged, said bearing comprising a fixed part and a rotary part forming together a bearing area wherein rolling bodies are arranged to enable the relative rotation of said parts, said confinement comprising a lubricant for the torque transmission part and said bearing area comprising a porous polymer matrix which encapsulates a lubricant for the operation of the bearing, said porous matrix being provided to be in contact with the rolling bodies, at least on a part of the periphery thereof.

### BRIEF DESCRIPTION OF THE DRAWINGS

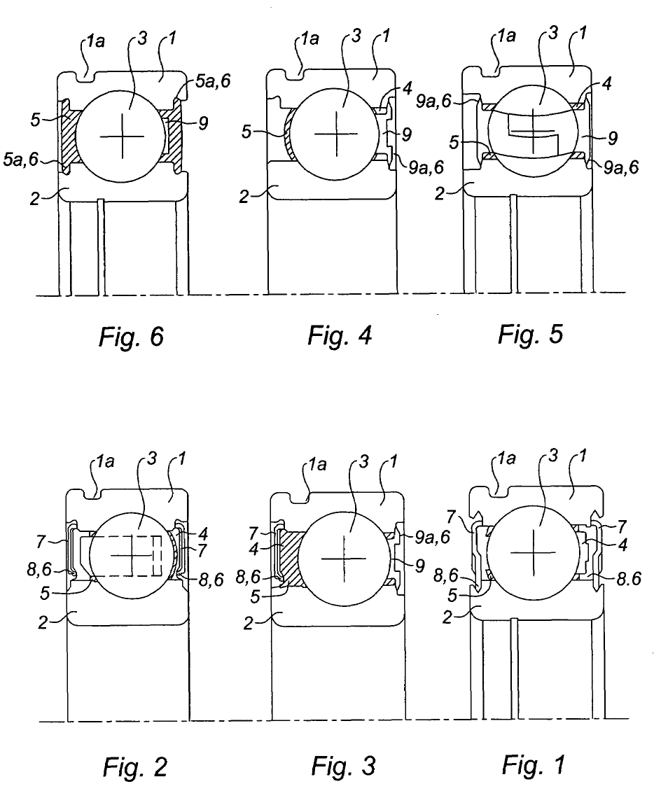

Other specificities and advantages of the invention will emerge in the following description with reference to the attached figures wherein FIGS. 1 to 6 are partial longitudinal section representations of a bearing for a torque transmission device according to one embodiment of the invention respectively.

### DETAILED DESCRIPTION OF THE PREFERRED EMBODIMENT(S)

The invention relates to a lubrication method of a torque transmission device comprising a confinement wherein at least one torque transmission part and at least one rotation guiding rolling bearing of said part are arranged. The method provides for a lubricant for the torque transmission part in the confinement.

In one example, the torque transmission device is a motor vehicle gearbox which comprises a casing wherein a lubricant, typically an oil, is arranged to lubricate the torque transmission pinions in particular. In this way, essentially, the lubricant contained in the casing fulfils its function with respect to the gearbox parts which are moving in the casing, particularly with respect to the pinions of said box.

However, the invention is not limited to this particular example, and may be applied to other torque transmission devices, and to torque transmission parts other than pinions.

To guide the rotation of the rotary parts contained in the casing, rolling bearings are provided in said casing, said bearings being in contact with the lubricant contained in said casing.

To this end, the bearings comprise a fixed part intended to be attached to a fixed part of the gearbox, for example to its casing, and a rotary part intended to be attached to a torque transmission part contained in said casing.

The fixed and rotary parts of the bearing form together a bearing area wherein rolling bodies are arranged to enable the relative rotation of said parts.

With reference to FIGS. 1 to 6, such a bearing formed from a bearing intended to be arranged in the casing of a motor vehicle gearbox is described. The bearing comprises a fixed outer ring 1, a rotary inner ring 2 and balls 3 arranged in the bearing area 4. In an alternative embodiment, it is possible to provide parts, rolling bodies and/or bearing areas which have different geometries according to the specific constraints of the target application. According to the embodiments represented, the outer ring 1 comprises a groove la intended to receive a stop ring used to immobilise the bearing in the gearbox.

The lubrication method provides in the bearing area 4 for a porous polymer matrix 5 which encapsulates a lubricant for the operation of the bearing.

According to one embodiment, the porous polymer matrix 5 is produced with a thermoplastic or duroplastic polymer base wherein a large quantity of lubricant is mixed. The mixture is then introduced into the bearing area 4 and then cross-linked, for example by heating, to ensure that it sets. In this way, a polymer matrix 5 which is fixed in the bearing area 4 is obtained, said matrix comprising porosities wherein the lubricant is encapsulated.

In one example, the polymer is polyethylene-based and the lubricant is an oil, a grease or a mixture of an oil and a grease.

By proportioning the quantity of mixture introduced into the bearing area 4, it is possible to place the porous matrix 5 in contact with the rolling bodies 3, at least on a part of the periphery thereof. According to one specific embodiment, the porous matrix 5 is provided to coat at least the free surface of the rolling bodies 3. In particular, the porous matrix 5 may be provided to comprise an annular body wherein the rolling bodies 3 are coated.

During the operation of the bearing, the invention makes it possible to supply the rolling bodies 3 with lubricant as close to the bearing contact as possible, without any risk of ejection of the lubricant outside the bearing area 4. Therefore, the bearing is autonomous with respect to its lubrication.

In addition, the at least partial filling of the bearing area 4 with the polymer matrix 5 makes it possible to limit the entries of oil from the box into said area, thus limiting the potential damage liable to be caused by pollutants contained in said oil. According to one specific embodiment, the porous matrix 5 is provided to fill the entire bearing area 4 substantially.

Moreover, the arrangement of the bearing lubricant in the porous matrix 5 makes it possible to protect said lubricant from the outside, particularly so as to prevent the washing thereof by the box oil. Therefore, the porous matrix 5 forms a lubricant reserve for the bearing, throughout its service life. In addition, it is possible to select a bearing lubricant which is optimal for this use, without any constraints with respect to the lubrication of the box or an interaction with the lubricant from said box.

In particular, it is possible to provide a gearbox wherein the lubricant encapsulated in the porous matrix 5 is different to that contained in the casing.

In addition, the use of a porous matrix 5 may enable the box oil to reach the bearing contact by means of capillarity without allowing the pollutants to pass. In this way, the mixture between the box oil and the lubricant contained in the porous matrix 5 may be selected to improve the operation of the bearing.

In addition, according to the target applications, it is possible to select a polymer-lubricant pair from a large number of combinations, rendering the lubrication method particularly versatile.

With reference to FIGS. 1 to 6, six embodiments of a gearbox bearing are described, wherein at least one side of the bearing area 4 is delimited axially by a means forming a deflector 6 between the outside of the bearing and said bearing area. The deflection means 6 particularly makes it possible to limit direct contact between the lubricant from the box and bearing tracks provided on each of the rings 1, 2. In particular, the deflection means 6 makes it possible to filter any pollutants contained in the box lubricant so as to limit the introduction thereof in the bearing area 4.

In this way, the deflection means 6 makes it possible to limit, in combination with the porous matrix 5, the adverse interactions between the inside of the casing and the bearing area 4, particularly with respect to their respective lubricant. In particular, the pollutants are filtered by the deflection means 6 and the porous matrix 5 prevents the contact between said pollutants and the bearing tracks.

In FIGS. 1 and 2, the bearing area 4 is delimited axially on either side respectively by a joint comprising a fixed reinforcement 7 attached to the fixed ring 1 and, moulded onto said reinforcement, a flexible lip 8 in frictional contact with the rotary ring 2.

According to these embodiments, the lip forms deflection means 6 in that it is intended to limit exchanges between the outside of the bearing and the bearing area 4, particularly by preventing the passage of solid bodies. However, in view of the fluidity of the box oil, the lip 8 in frictional contact can allow a part of the liquid lubricant to pass.

In FIG. 1, the porous matrix 5 is arranged to coat the periphery of the rolling bodies 3, in the vicinity of the bearing tracks which are formed on each of the rings.

In FIG. 2, the porous matrix 5 is arranged to coat the free surface of the rolling bodies 3.

In FIGS. 3 to 5, at least one of the joints is replaced by a deflection means 6 formed on an outer edge of a part of the retention cage 9 of the rolling bodies 3 in the bearing area 4.

To this end, the cage 9 is produced according to the disclosure of the document FR-2 787 530, i.e. comprising an annular body provided with housings in the form of a hemispherical cap opening onto a transversal edge of said body, the other edge comprising an annular deflector 9a extending generally radially.

According to this embodiment, it is possible to adjust the relative arrangement of the deflector 9a and the rings 1, 2 to control the passage of the lubricant of the box inside the bearing area 4. In particular, the clearances between the deflector 9a and the surfaces of the rings 1, 2 arranged facing each other may be adjusted to limit the passage of the pollutants contained in the box oil. This embodiment, in combination with the presence of the porous matrix 5 in the bearing area 4, makes it possible to protect the bearing by preventing any contact between the pollutants and the bearing tracks.

In addition, it is possible to provide for the reinforcement of at least one of the rings 1, 2 of the bearing to, in the event of such contact, limit the damage caused. In particular, such a reinforcement may be obtained by means of a specific treatment of at least the surface of the steel forming the ring 1, 2, for example by means of known thermal, mechanical or thermochemical treatments.

In FIG. 3, the bearing area 4 is delimited axially by a joint in accordance with that in FIGS. 1 and 2, and an annular body comprising a deflector 9a. In this embodiment, the porous matrix 5 fills the entire bearing area 4 substantially.

In FIG. 4, the bearing area 4 is delimited on one side by a deflector 9a in accordance with FIG. 3. In this way, on the side opposite the deflector 9a, only the porous matrix 5 ensures the protection of the bearing area 4. For this purpose, the porous matrix 5 is provided to coat the entire free surface of the rolling bodies 3, including the part arranged opposite the deflector 9a.

In FIG. 5, the retention cage is formed by two bodies each provided with a deflector 9a, said bodies cooperating to form housings wherein the rolling bodies 3 are retained. This figure shows a total filling of the bearing area 4 with the porous matrix 5, from one deflector 9a to the other deflector 9a.

FIG. 6 represents an embodiment wherein the porous matrix 5 comprises an annular body on each of the outer edges from which a means forming a deflector 5a is produced. In an alternative embodiment, it is possible to provide for the production of a deflection means 5a on only one of the edges of the porous matrix 5, the other side of the area 4 possibly being equipped according to any of the above embodiments.

According to FIG. 6, the porous matrix 5 makes it possible, due to its presence in the entire bearing area 4, to prevent the introduction of external elements into the bearing area. In addition, the porous matrix 5 incorporates, in one part, the deflector function 6 so as to limit direct contact between the lubricant from the box and the area of the matrix 5 which is arranged in the vicinity of the bearing tracks.

What is claimed:

1. Lubrication method of a torque transmission device, said device comprising a confinement wherein at least one torque transmission part and at least one rotation guiding rolling bearing of said part are arranged, said bearing comprising a fixed part and a rotary part forming together a bearing area wherein rolling bodies are arranged to enable the relative rotation of said parts, said method comprising providing in the confinement a lubricant for the torque transmission part and providing in the bearing area a porous polymer matrix which encapsulates a lubricant for the operation of the bearing, and providing said porous matrix to be in contact with the rolling bodies, at least on a part of a periphery thereof.

2. Lubrication method according to claim 1, wherein the porous matrix providing step comprises providing the porous matrix to coat a free surface of the rolling bodies.

3. Lubrication method according to claim 2, wherein the porous matrix providing step comprises providing the porous matrix to comprise an annular body wherein the rolling bodies are coated.

4. Lubrication method according to claim 1, wherein the porous matrix providing step comprises providing the porous matrix to substantially fill an entire bearing area.

5. Lubrication method according to claim 1, further comprising selecting the lubricant for the operation of the bearing from the group consisting of an oil, a grease and a mixture of an oil and a grease.

6. Torque transmission device comprising a confinement wherein at least one torque transmission part and at least one rotation guiding rolling bearing are arranged, said bearing comprising a fixed part and a rotary part forming together a bearing area wherein rolling bodies are arranged to enable the relative rotation of said parts, said confinement comprising a lubricant for the at least one torque transmission part and said bearing area comprising a porous polymer matrix which encapsulates a lubricant for the operation of the bearing, and said porous matrix being provided to be in contact with the rolling bodies, at least on a part of a periphery thereof.

7. Torque transmission device according to claim 6, wherein the lubricant encapsulated in the porous matrix is different than that contained in the confinement.

8. Torque transmission device according to claim 6, wherein at least one side of the bearing area is delimited axially by a means forming a deflector between an outside of the bearing and said bearing area.

9. Torque transmission device according to claim 8, wherein the means forming the deflector is produced on an outer edge of at least part of a retention cage of the rolling bodies in the bearing area.

10. Torque transmission device according to claim 8, wherein the porous matrix comprises an annular body on at least an outer edge of which the means forming a deflector is produced.
